(19) United States
(12) Patent Application Publication
(10) Pub. No.: US 2012/0019447 A1
(43) Pub. Date: Jan. 26, 2012

(54) DIGITAL DISPLAY DEVICE

(76) Inventor: David H. Hanes, Loveland, CO (US)

(21) Appl. No.: 13/260,348

(22) PCT Filed: Oct. 2, 2009
(86) PCT No.: PCT/US09/59415

§ 371 Date: Sep. 25, 2011

(51) Int. Cl. G09G 5/00; G06F 3/02; G09G 5/02

(52) U.S. Cl. 345/168; 345/156; 345/589

(57) ABSTRACT

A method for configuring a digital display device including determining whether a user is viewing the digital display device with a sensor, identifying an amount of ambient light around the digital display device with the sensor, and configuring one or more display settings on the digital display device in response to whether the user is viewing the digital display device and the amount of ambient light identified.

### BACKGROUND

When configuring one or more settings on a digital display device, a user accesses one or more input devices on the digital display device. The user can utilize one or more of the input devices to access and modify one or more settings of the digital display device until the user becomes satisfied with a configuration of the digital display device. The digital display device can then update one or more of the settings on the digital display device in response to the modifications made by the user.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the embodiments.

FIG. 1 illustrates a machine coupled to a digital display device and a sensor according to an embodiment of the invention.

FIG. 2 illustrates a sensor determining whether a user is viewing a digital display device and measuring an amount of ambient light around the digital display device according to an embodiment of the invention.

FIG. 3 illustrates a sensor capturing a user interfacing with a digital display device according to an embodiment of the invention.

FIG. 4 illustrates a display application configuring one or more display settings on a digital display device in response to information captured from a sensor according to an embodiment of the invention.

FIG. 5 illustrates a machine with an embedded display application and a display application stored on a removable medium being accessed by the machine according to an embodiment of the invention.

FIG. 6 is a flow chart illustrating a method for configuring a digital display device according to an embodiment of the invention.

FIG. 7 is a flow chart illustrating a method for configuring a digital display device according to another embodiment of the invention.

### DETAILED DESCRIPTION

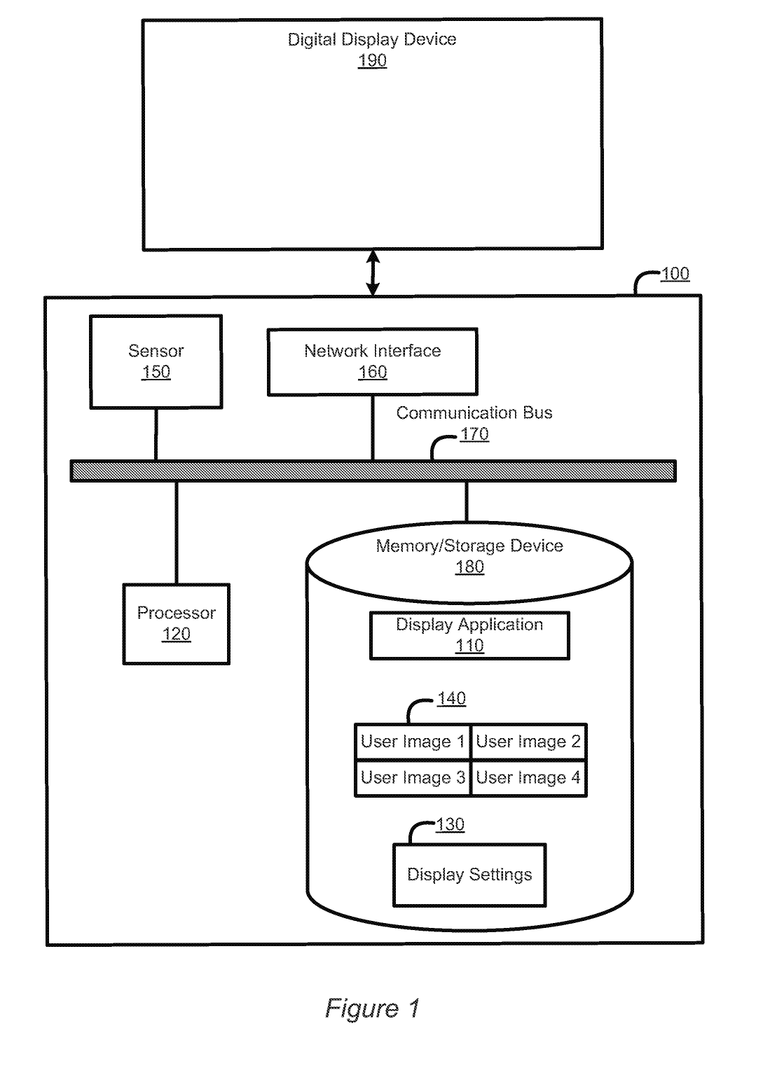

FIG. 1 illustrates a machine 100 coupled to a digital display device 190 and a sensor 150 according to an embodiment of the invention. In one embodiment, the machine 100 is a digital photo frame. In other embodiments, the machine 100 is a desktop, a laptop, a server, and/or any device that a digital display device 190 is coupled to. As illustrated in FIG. 1, the machine 100 is coupled to the digital display device 190 and includes a processor 120, one or more sensors 150, a memory/storage device 180, a network interface 160, and a communication bus 170 for the machine 100 and/or one or more components of the machine 100 to communicate with one another.

Further, as illustrated in FIG. 1, the memory/storage device 180 stores a display application 110, one or more user images 140, and display settings for the digital display device 130. In another embodiment, the memory/storage device 180 additionally stores media that can be rendered for display by the display application 110. In other embodiments, the machine 100 includes additional components and/or is coupled to additional components in addition to and/or in lieu of those noted above and illustrated in FIG. 1.

As noted above, the machine 100 includes a processor 120. The processor 120 sends data and/or instructions to the components of the machine 100, such as one or more sensors 150, the memory/storage device 180, the digital display device 190, and the display application 110. Additionally, the processor 120 receives data and/or instruction from components of the machine 100, such as the display application 110.

The display application 110 is an application which can configure the digital display device 190. In configuring the digital display device 190, the display application 110 utilizes one or more sensors 150 to determine whether the user is viewing the digital display device 190. Additionally, the display application 110 can additionally utilize one or more sensors 150 to identify an amount of ambient light around the digital display device 190. In response to determining whether a user is viewing the digital display device 190 and an amount of ambient light identified around the digital display device 190, the display application 110 can configure the digital display device 190 by modifying one or more display settings 130 on the digital display device 190. In one embodiment, the display application 110 can further configure one or more display settings 130 on the digital display device in response to inputs received from the user.

The display application 110 can be firmware which is embedded onto the machine 100. In other embodiments, the display application 110 is a software application stored on the machine 100 within ROM or on a storage device 180 accessible by the machine 100 or the display application 110 is stored on a computer readable medium readable and accessible by the machine 100 from a different location. Additionally, in one embodiment, the storage device 180 is included in the machine 100. In other embodiments, the storage device 180 is not included in the machine 100, but is accessible to the machine 100 utilizing a network interface 160 included in the machine 100. The network interface 160 may be a wired or wireless network interface card.

In a further embodiment, the display application 110 is stored and/or accessed through a server coupled through a local area network or a wide area network. The display application 110 communicates with devices and/or components coupled to the machine 100 physically or wirelessly through a communication bus 170 included in or attached to the machine 100. In one embodiment the communication bus 170 is a memory bus. In other embodiments, the communication bus 170 is a data bus.

As noted above, the display application 110 can configure the digital display device 190 by modifying one or more display settings 130 on the digital display device 190. The digital display device 190 is a device that can be configured by display application 110 to display, and/or project media, such as one or more images and/or video streams. Additionally, the digital display device 190 can be configured by the display application 110 to display one or more interfaces for the user to interact with when entering inputs. In one embodiment, the digital display device 190 is a monitor and/or television. In another embodiment, the digital display device 190 is a projector and/or a touch screen.

As noted above, the digital display device 190 can be configured by the display application 110. The digital display device 190 can have one or more corresponding display settings 130. One or more of the corresponding settings 130 can have levels and/or values which can be controlled and/or modified by the display application 110.

In one embodiment, one or more of the display settings 130 can include a brightness level, a contrast level, a back light level, a saturation level, a sharpness level, a color temperature level, and/or a power consumption level. In other embodiments, one or more of the display settings 130 can include additional levels and/or values which can be modified by the display application 110 in addition to and/or in lieu of those noted above.

As illustrated in FIG. 1, in one embodiment, one or more of the display settings 130 can be stored on and/or modified from the memory/storage device 180. By increasing or decreasing one or more values and/or levels in the display settings 130, the display application 110 can configure the display output of the digital display device 190 to match ambient light conditions. Additionally, by modifying one or more of the values and/or levels in the display settings 130, the display application 110 can control and/or change an amount of power consumption for the digital display device 190.

Further, by lowering one or more of the levels and/or values in the display settings 130, one or more additional levels and or values can also be modified. In one embodiment, the display application 110 can configure the digital display device 190 by lowering a power consumption level in the display settings 130. In response to lowering the power consumption level in the display settings 130, the digital display device 190 can utilize less power and be in a low power consumption mode. Additionally, in response to lowering the power consumption level, one or more of the additional levels and/or values in the display settings 130 can be decreased as to prohibit a user from viewing and/or configuring the digital display device 190.

As noted above, the display application 110 initially utilizes one or more sensors 150 to detect and capture information of an environment around the digital display device 190 before configuring one or more of the display settings 130. The information can specify whether a user is present around the digital display device 190, whether the user is viewing the digital display device 190, whether the user is authorized to view and/or configure the digital display device 190, one or more input commands received from the user, and/or an amount of ambient light around the digital display device 190. One or more of the sensors 150 can detect and capture the information sequentially and/or in parallel.

In one embodiment, one or more of the sensors 150 include a camera. In another embodiment, one or more of the sensors include an infra red device. In other embodiments, one or more of the sensors 150 can be additional devices configured by the display application 110 to detect and capture information of the environment around the digital display device 190. One or more of the sensors 150 can be integrated as part of the machine 100 and/or the digital display device 190. Additionally, one or more of the sensors 150 can be coupled to the machine 100 and/or the digital display device 190.

As noted above, the display application 110 can initially utilize one or more of the sensors 150 to determine whether a user is around the digital display device 190. In one embodiment, the display application 110 can configure one or more of the sensors 150 to scan for any motion or movement around the digital display device 190. If any movement is detected, the display application can proceed to determine whether the user is viewing the digital display device 190.

For the purposes of this application, the user is considered to be viewing the digital display device 190 when the digital display device 190 is within a line of sight of the user. As a result, the digital display device 190 will be within the viewing location of the user. The display application 110 can configure one or more of the sensors 150 to identify a head position of the user and/or a location of the user's eyes. In another embodiment, the display application 110 additionally utilizes facial detection technology to identify the head position of the user. The facial detection technology can be software and/or hardware based.

In one embodiment, one or more of the sensors 150 will proceed to scan for a face of the user. In another embodiment, one or more of the sensors 150 will proceed to utilize infra red technology to scan for the user's eyes. If one or more of the sensors 150 capture the eyes or face of the user, the display application 110 will determine that the viewing location of the user is the digital display device 190 and the user is viewing the digital display device 190.

The display application 110 can additionally determine whether the user is authorized to view the digital display device 190. In determining whether the user is authorized to view the digital display device 190, the display application 110 will proceed to authenticate the user. The display application 110 can utilize facial recognition technology to authenticate the user. The display application 110 can instruct one or more of the sensors 150 to capture an image of the user and compare the captured image to one or more user images 140 stored on the memory/storage device 180.

One or more of the user images 140 are digital images of users which have been registered with the machine 100 and have been authorized to view the digital display device 190. In another embodiment, the display application 110 can configure one or more of the sensors 150 to capture a voice of the user and/or a motion made by the user. If the display application 110 finds a matching user image 140, voice, and/or pattern, then the display application 110 will determine that the user is authorized to view the digital display device 190.

In one embodiment, if the display application 110 determines that the user is not viewing the digital display device 190 or the user is not authorized to view the digital display device 190, the display application 110 can proceed to configure the digital display device 190 by lowering a power consumption level to reduce an amount of power consumed by the digital display device 190. As noted above, by lowering the power consumption level, the user can also be prohibited from viewing and/or configuring the digital display device 190.

Additionally, as noted above, the display application 110 can utilize one or more of the sensors 150 to identify an amount of ambient light around the digital display device 190. In identifying the amount of ambient light, one or more of the sensors 150 can detect and measure an amount of light emitted from one or more light sources in an environment where the digital display device 190 is located. One or more light sources can be natural and/or artificial. In one embodiment, one or more light sources include a lamp or any other device that can produce or output light.

The display application 110 can utilize the measurements from one or more of the sensors 150 to determine the brightness level of all of the light sources and to identify the amount of ambient light around the digital display device 190. In one embodiment, the display application 110 can additionally utilize one or more sensors 150 to determine a color of the ambient light. Once the display application 110 has determined whether the user is viewing the digital display device 190, identified the amount of ambient light around the digital display device 190, and/or a color of the ambient light, the digital display device 190 can proceed to configure the digital display device 190.

As noted above, the digital display device 190 can further be configured in response to the user entering one or more inputs for the display application 110 to interpret and process. One or more of the inputs can specify which of the display settings to configure. Additionally, one or more of the inputs can specify whether to increase or decrease one or more of the levels and/or values.

In one embodiment, the display application 110 can initially determine whether the user is authorized to configure the digital display device 190 before interpreting and processing the inputs from the user. As noted above, the display application 110 can utilize facial recognition technology, voice recognition technology, and/or pattern recognition technology to authenticate the user. Once the user has been authenticated, one or more of the sensors 150 can be configured to detect and capture one or more hand movements and/or one or more finger movements made by the user. In another embodiment, the digital display device 190 can additionally be configured to display an interface for the user to interact with. The interface can include one or more buttons, text, and/or pictures. In one embodiment, the interface can be a keyboard.

The user can interact with the interface to enter one or more gestures for one or more of the sensors 150 to detect and capture. In one embodiment, one or more of the gestures are hand and/or finger gestures. The display application 110 can interpret one or more of the captured hand and/or finger movements to identify one or more inputs made by the user. The display application 110 can then further configure one or more display settings 130 on the digital display device 190 in response to the inputs.

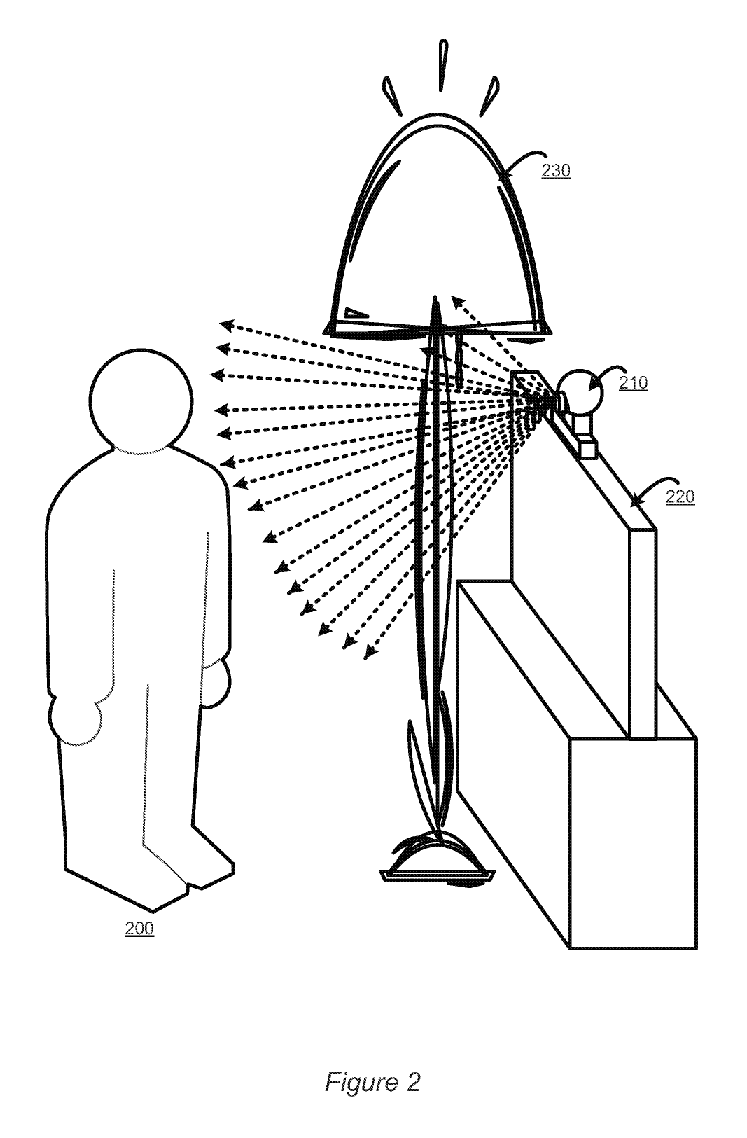

FIG. 2 illustrates a sensor 210 determining whether a user 200 is viewing a digital display device 220 and measuring an amount of ambient light around the digital display device 220 according to an embodiment of the invention. As noted above and as illustrated in FIG. 2, in one embodiment, one or more of the sensors 210 include a camera. Additionally, one or more of the sensors 210 can be coupled to the digital display device 220.

As noted above, a display application can configure the sensor 210 to scan an environment where the digital display device is located to determine whether a user 200 is viewing the digital display device 220 and an amount of ambient light around the digital display device 220. Further, as noted above, a user 200 is viewing the digital display device 220 when the digital display device 220 is in a line of sight of the user 200.

As shown in FIG. 2, the sensor 210 initially detects that there is a user in front of the digital display device 220. Once the sensor 210 determines that a user is present in the environment, the sensor 210 proceeds to identify a head position of the user 200 and a viewing location of the user 200 to determine whether the user 200 is viewing the digital display device 220. The digital display application can additionally utilize facial detection technology when in identifying a head location of the user and determining whether the user is viewing the digital display device 220.

In another embodiment, the display application utilizes infra red technology to determine whether the user 200 is viewing the digital display device 220. As noted above and as shown in FIG. 2, if the sensor 210 detects and captures the eyes or the face of the user 200, the display application will determine that the viewing location of the user 200 is the digital display device 220.

Further, as noted above, the sensor 210 can identify an amount of ambient light in the environment where the digital display device 220 is located. As illustrated in FIG. 2, in one embodiment, the environment includes a light source 230 which can output light and provide ambient light for the digital display device. Additionally as shown in FIG. 2, the sensor 210 detects the light from the light source 230 and proceeds to identify an amount of the ambient light.

As noted above, the sensor 210 can measure an intensity and a brightness level of the ambient light to transfer to the display application. The display application can then utilize the measurements to identify an amount of the ambient light. As noted above, in one embodiment, the display application in conjunction with the sensor 210 can additionally identify a color of the ambient light. Once the display application has determined whether the user 200 is viewing the digital display device 220 and the amount of ambient light around the digital display device, the display application can proceed to configure one or more settings on the digital display device 220.

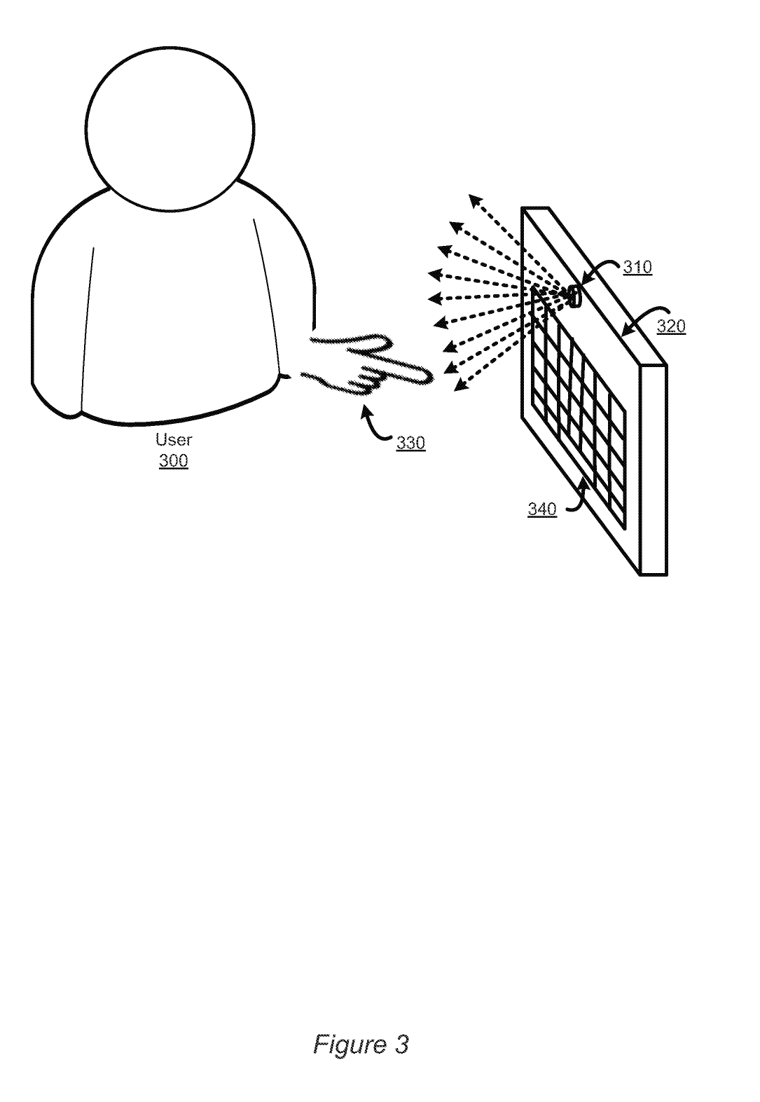

FIG. 3 illustrates a sensor 310 detecting a user 300 interfacing with a digital display device 320 according to an embodiment of the invention. In one embodiment, as illustrated in FIG. 3, one or more sensors 310 can be a camera which is integrated with the digital display device 320. As noted above, the digital display device 320 can be configured in response to whether the user 300 is viewing the digital display device 320 and an ambient light level around the digital display device 320. Additionally, one or more display settings on the digital display device 320 can further be configured by the user 300 entering one or more inputs,

As illustrated in FIG. 3, one or more sensors 310 can be configured by a display application to detect and capture hand and/or finger motions 330 and interpret the captured hand and/or finger motions 330 as inputs. As noted above, one or more of the inputs can specify which of the display settings to configure. Additionally, one or more of the inputs can specify whether to increase or decrease one or more of the levels and/or values.

Additionally, as noted above, before capturing and interpreting one or more hand and/or finger motions 330 from the user 300, the display application can utilize the sensor 310 to authenticate the user 300 to determine whether the user 300 is authorized to configure the digital display device 320. The display application can utilize facial recognition technology, voice recognition technology, and/or motion recognition technology when authenticating the user 300.

As illustrated in FIG. 3, in one embodiment, the sensor 310 scans a face of the user 300 and/or the hand motion 330 made by the user 300 to determine whether the user 300 is authorized to configure the digital display device 320. In one embodiment, if the display application authenticates the user 300 and determines that the user 300 is authorized to configure the digital display device 320, the display application then configures the digital display device 320 to display an interface 340 for the user to interact with.

In another embodiment, if the display application determines that the user 300 is not authorized to configure the digital display device 320, the display application can proceed to configure the digital display device 320 by modifying one or more display settings of the digital display device 320.

As noted above, the interface can include, one or more pictures, text, and/or buttons. In one embodiment, as illustrated in FIG. 3, the interface is a keyboard. As shown in FIG. 3, the user 300 can interact with the interface 340 by making one or more hand and/or finger motions 330. Additionally, as shown in FIG. 3, the sensor 310 detects and captures the hand and/or finger motion 330.

In the present embodiment, the user 300 is making a hand and/or finger motion which includes the user 300 pointing at a location on the interface 340. The sensor 310 determines that the user 300 is pointing and identifies the location on the interface 340 where the user 300 is pointing. In response to identifying the type of hand and/or finger motion 330 and determining where the user 300 is pointing, the display application can interpret one or more inputs.

Once the display application has identified one or more inputs from the user 300, the display application can further configure the digital display device 320 by modifying one or more display settings on the digital display device 320.

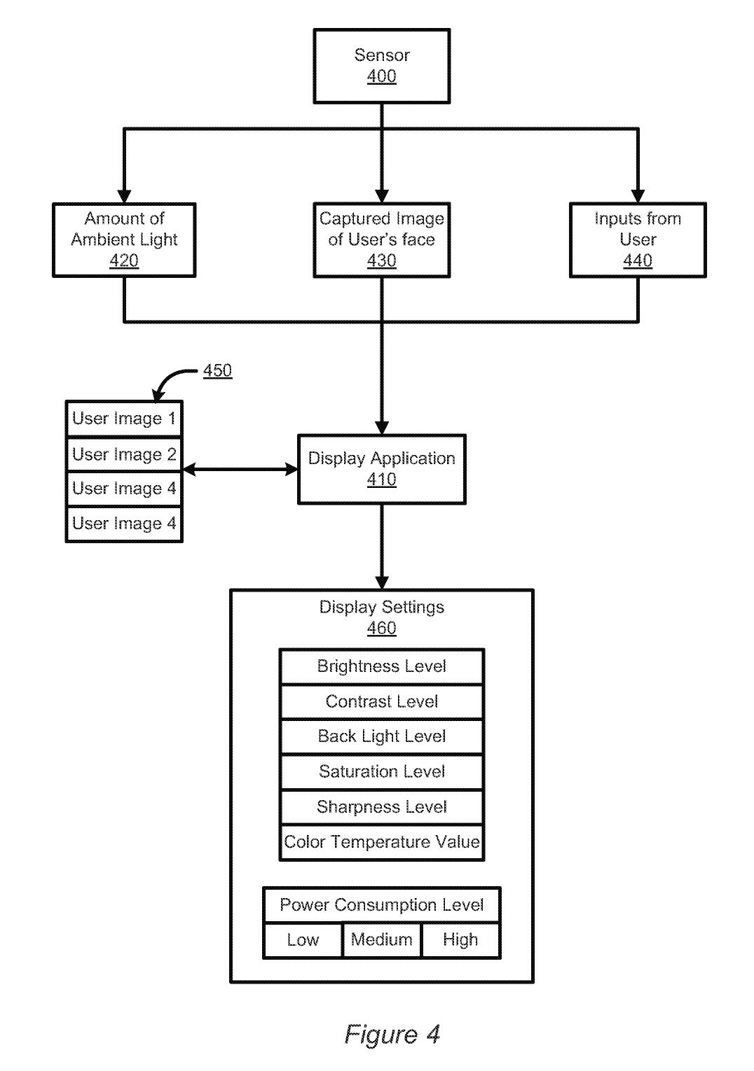

FIG. 4 illustrates a display application 410 configuring one or more display settings 460 on a digital display device in response to information 420, 430, 440 captured from a sensor 400 according to an embodiment of the invention. As noted above, the information 420, 430, 440 can specify whether a user is viewing the digital display device, whether the user is authorized to view and/or configure the digital display device, an amount of ambient light around the digital display device, and/or one or more inputs entered by the user.

As illustrated in FIG. 4, the display application 410 utilizes one or more sensors 400 to capture the information 420, 430, 440. As noted above, the display application 410 can additionally utilize facial detection and/or recognition technology when determining whether the user is viewing the digital display device and whether the user is authorized to view or configure the digital display device.

In response to the amount of ambient light identified in the environment 420, whether a user is viewing the digital display device, whether the user is authorized to view or configure the digital display device, and/or inputs received from the user 440, the display application 410 can proceed to configure the digital display device by modifying one or more display settings 460 on the digital display device.

As noted above, if the display application 410 does not detect a face and/or eyes of the user or the display application determines that the captured image of the user's face 430 does not match one or more user images 450, the display application 410 can proceed to configure the digital display device by lowering a power consumption level in the display settings 460. In the present embodiment, the display application 410 can decrease the power consumption level from a medium or high level to a low level.

In response to lowering the power consumption level, one or more additional levels in the display settings 460 can be modified. In the present embodiment, by lowering the power consumption level, the display application can also reduce the brightness level, the contrast level, and/or the back light level. As a result, a display output of the digital display device can appear to be blank and/or black. Further, the digital display device can utilize less power and the user can also be prohibited from viewing the digital display device.

In another embodiment, the display application 410 can additionally increase the power consumption level from a low level to a medium or high level. In response to increasing the power consumption level, one or more additionally levels in the display settings 460 can be modified. As a result, a display output of the digital display device can be made visible and the user can be allowed to view the digital display device.

In addition, as noted above, in response to an amount of ambient light 420 identified from the sensor 400, the display application can increase and/or decrease one or more of the display settings 460 to match the identified amount of ambient light 420 around the digital display device. In one embodiment, if the display application 410 determines that the amount of ambient light is high, the display application can proceed to increase the brightness level, contrast level, and/or back light level in order to make display output of the digital display appear more visible to the user.

Additionally, as noted above, in one embodiment, the display application 410 can utilize the sensor 400 to identify a color of the ambient light as well. In response to the color of the ambient light, the display application 410 can additionally adjust a saturation level and/or color temperature level of the display settings to additionally match or blend with the color of the ambient light.

In one embodiment, the display application 410 can also interpret inputs from the user 440 to further configure the display device. As noted above, the display application 410 can initially determine whether the user is authorized to configure the digital display device. If the user is authorized to configure the digital display device, the display application 410 can configure the sensor 400 to detect and capture one or more hand and/or finger motions. The display application 410 will then interpret the inputs from the user 440 and proceed to additionally configure one or more of the display settings 460 in response to the inputs.

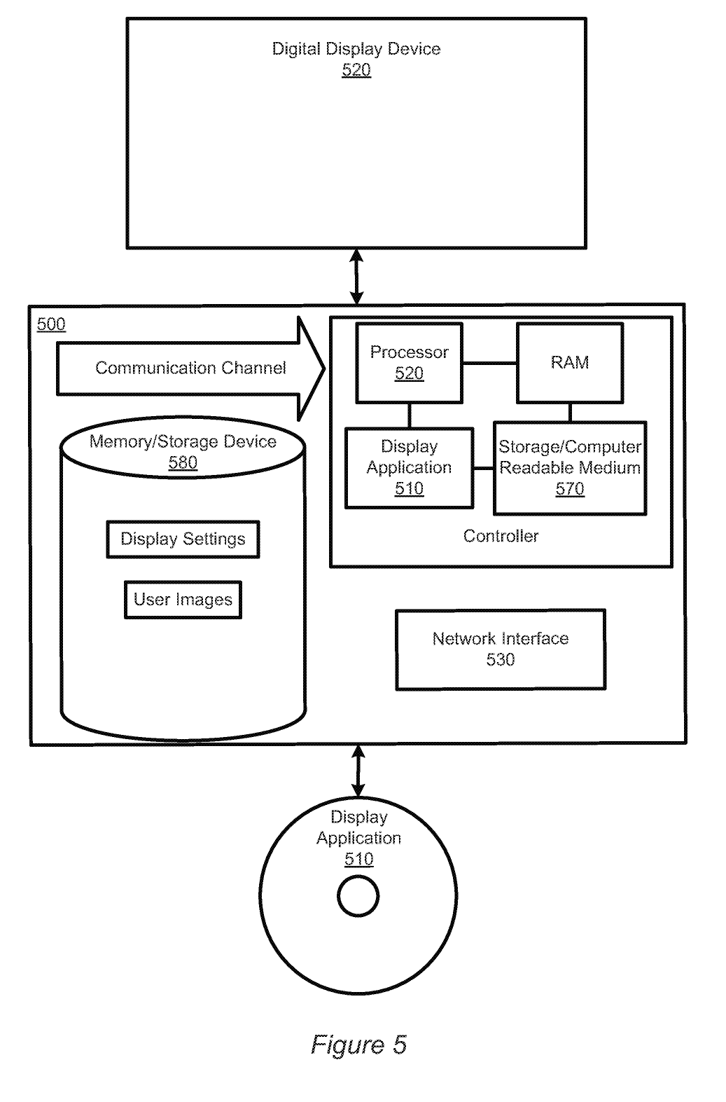

FIG. 5 illustrates a machine with a display application 510 and a display application 510 stored on a removable medium being accessed by the machine 500 according to an embodiment of the invention. For the purposes of this description, a removable medium is any tangible apparatus that contains, stores, communicates, or transports the application for use by or in connection with the machine 500. As noted above, in one embodiment, the display application 510 is firmware that is embedded into one or more components of the machine 500 as ROM. In other embodiments, the display application 510 is a software application which is stored and accessed from a hard drive, a compact disc, a flash disk, a network drive or any other form of computer readable medium that is coupled to the machine 500.

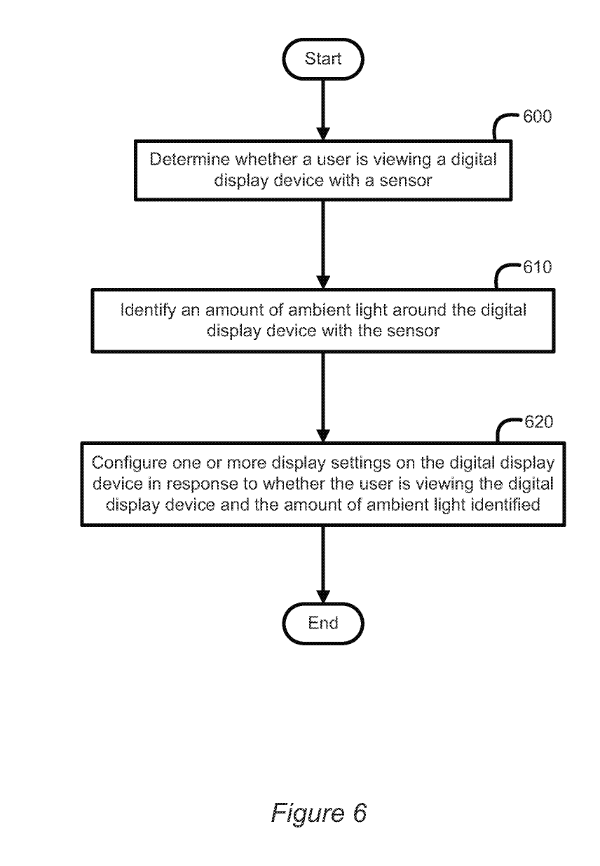

FIG. 6 is a flow chart illustrating a method for configuring a digital display device according to an embodiment of the invention. The method of FIG. 6 uses a machine coupled to a digital display device, one or more sensors, and a display application. In other embodiments, the method of FIG. 6 uses additional components and/or devices in addition to and/or in lieu of those noted above and illustrated in FIGS. 1, 2, 3, 4, and 5.

As noted above, a display application initially configures one or more sensors to determine whether a user is viewing a digital display device 600. Additionally, as noted above, one or more sensors can include a camera configured to identify a head position of the user and/or a viewing location of the user. In one embodiment, when determining whether the user is viewing the digital display device, the display application additionally utilizes facial detection technology or eye tracking technology. As noted above, the facial detection technology and the eye technology can be hardware and/or software based.

In one embodiment, if the display application determines that the user is not viewing the digital display device, the display device can configure the digital display device by decreasing a power consumption level of the display settings. By decreasing the power consumption level, the digital display device can power off or enter a sleep mode. In another embodiment, decreasing the power consumption level can additionally decrease one or more additional display settings. As a result, a display output of the digital display device can appear to dim or not be visible.

Additionally, the display application can determine whether the user is authorized to view and/or configure the digital display device. In determining whether the user is authorized to view and/or configure the digital display device, the display application will proceed to authenticate the user. In authenticating the user, the display application can utilize facial recognition technology to identify the user. The facial recognition technology can be hardware and/or software based. In another embodiment, the display application, in conjunction with one or more of the sensors, can use voice recognition technology and/or pattern recognition technology when authenticating the user.

If the user is not authorized to view the digital display device, the display application will configure the digital display device by decreasing the power consumption level. If the user is authorized to view the digital display device, the video application will then proceed to configure one or more of the sensors to identify an amount of ambient light around the digital display device 610.

In measuring the amount of ambient light, one or more of the sensors can detect an amount of light emitted from one or more light sources in an environment where the digital display device is located. The display application can then determine the brightness level of all of the light sources to determine the amount of ambient light. In one embodiment, the display application can additionally utilize one or more sensors to determine a color of the ambient light.

As noted above, the display application can additionally authenticate the user and determine whether the user is authorized to configure one or more settings on the digital display device. If the user is not authorized to configure one or more settings on the digital display device, the display application can proceed to configure one or more settings of the digital display device in response to whether the user is viewing the digital display device and the amount of ambient light identified 620.

If the user is authorized to configure one or more settings on the digital display device, in one embodiment, the display device application can additionally configure one or more of the sensors to detect and capture one or more hand movements and/or one or more finger movements from the user. The display application can interpret the hand and/or finger movements as one or more inputs which the user is entering to further configure one or more of the display settings.

Further, the display application can configure the digital display application to display an interface for the user to interact with. The interface can include one or more buttons, images, and/or text. In one embodiment, the interface is a keyboard. Once the display application has identified one or more of the inputs, the display application can configure one or more settings of the digital display device in response to whether the user is viewing the digital display device, the amount of ambient light identified, and one or more of the inputs.

The method is then complete or the display application can proceed to configure one or more settings on the digital display device in response to whether a user is viewing the digital display device, an ambient light level around the digital display device, and/or one or more inputs from the user. In other embodiments, the method of FIG. 6 includes additional steps in addition to and/or in lieu of those depicted in FIG. 6.

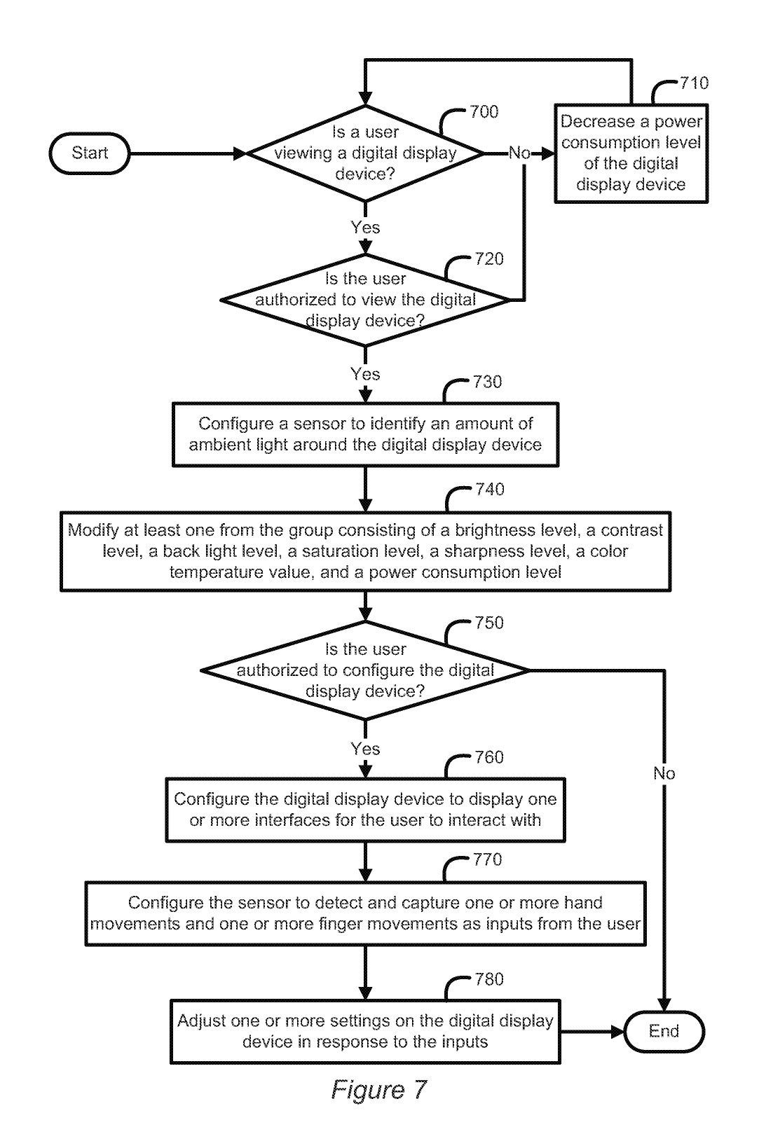

FIG. 7 is a flow chart illustrating a method for configuring a digital display device according to another embodiment of the invention. Similar to the method of FIG. 6, the method of FIG. 7 uses a machine coupled to a digital display device, one or more sensors, and a display application. In other embodiments, the method of FIG. 7 uses additional components and/or devices in addition to and/or in lieu of those noted above and illustrated in FIGS. 1, 2, 3, 4 and 5.

As noted above, a display application initially determines whether a user is viewing a digital display device 700. In determining whether a user is viewing the digital display device, the display application can configure one or more sensors to detect and identify a head or eye position of the user to determine a viewing location of the user. As noted above, one or more of the sensors can be integrated with the machine and/or the digital display device. In other embodiments, one or more of the sensors can be coupled to the machine and/or the digital display device. Additionally, the display application can utilize face detection technology in determining whether the user is viewing the digital display device.

In one embodiment, if the display application determines that the user is not viewing the digital display device, the display device can configure the digital display device by decreasing a power consumption level of the digital display device 710. If the display application determines that a user is viewing the digital display device, the display application can proceed to determine whether the user is authorized to view the digital display device 720. In determining whether the user is authorized to view the digital display device, the display application will proceed to authenticate the user.

As noted above, when authenticating the user, the display application can utilize facial recognition technology, voice recognition technology, and/or pattern recognition technology when authenticating the user. In other embodiments, the user can be authenticated by the user accessing one or more input buttons on the digital display device.

If the user is not authorized to view the digital display device, the display application will configure the digital display device to decrease the power consumption level of the digital display device 710. As noted above, by decreasing the power consumption level, the user can be prohibited from viewing the digital display device as a result of a brightness level, a contrast level, and/or a back light additionally being decreased to decrease or prohibit visibility of a display output of the digital display device.

The display application can then continue to determine whether the user is viewing the digital display device 700 and proceed to determine whether the user is authorized to view the digital display device 720. If the user is authorized to view the digital display device, the display application will then proceed to configure one or more of the sensors to identify an amount of ambient light around the digital display device 730.

As noted above, in identifying an amount of ambient light, one or more of the sensors can detect an amount of light emitted from one or more light sources in an environment where the digital display device is located. The display application can then determine the brightness level of all of the light sources 10 determine the amount of ambient light. Further, the display application can utilize one or more sensors to determine a color of the ambient light.

Once the display application has determined whether a user is viewing the digital display and identified an amount of ambient light around the digital display device, the display application can proceed to configure one or more settings on the digital display device. In configuring one or more of the settings, the display application will modify at least one from the group consisting of a brightness level, a contrast level, a back light level, a saturation level, a sharpness level, a color temperature level, and a power consumption level 740.

As noted above, one or more of the display settings are modified so that the display output of the digital display device will match the ambient light levels and/or color identified by one or more of the sensors. Additionally, as noted above, the display application can additionally authenticate the user and determine whether the user is authorized to configure one or more settings on the digital display device 750. If the user is not authorized to configure one or more settings on the digital display device, the process is then complete.

If the user is authorized to configure one or more settings on the digital display device, in one embodiment, the display device application can configure the digital display application to display an interface for the user to interact with 760. As noted above, in one embodiment, the interface displayed is a keyboard. Additionally, the display application can configure one or more of the sensors to detect and capture one or more hand movements and/or one or more finger movements from the user 770. The display application can interpret the hand and/or finger movements as one or more inputs which the user is entering to further configure one or more of the display settings.

Once the display application has identified one or more of the inputs, the display application can further adjust one or more settings of the digital display device in response to one or more of the inputs 780. The method is then complete or the display application can proceed to configure one or more settings on the digital display device in response to whether a user is viewing the digital display device, an ambient light level around the digital display device, and/or one or more inputs from the user. In other embodiments, the method of FIG. 7 includes additional steps in addition to and/or in lieu of those depicted in FIG. 7.

By configuring a digital display device in response to information captured by a sensor, one or more settings of the digital display device can accurately and promptly be configured. As a result, time is saved for a user and a more pleasant and convenient user experience is created. Additionally, by decreasing a power consumption level from the display settings when the user is not viewing the digital display device or when the user is not authorized to configure the digital display device, power can be saved and security for the digital display device can be increased.

What is claimed is:

1. A method for configuring a digital display device comprising:
determining whether a user is viewing the digital display device with a sensor;
identifying an amount of ambient light around the digital display device with the sensor; and
configuring one or more display settings on the digital display device in response to whether the user is viewing the digital display device and the amount of ambient light identified.

2. The method for configuring a digital display device of claim 1 further comprising utilizing facial detection technology when determining whether a user is currently viewing the digital display device.

3. The method for configuring a digital display device of claim 1 further comprising determining whether the user is authorized to view or configure the digital display device.

4. The method for configuring a digital display device of claim 3 further comprising utilizing facial recognition technology to determine whether the user is authorized to view or configure the digital display device.

5. The method for configuring a digital display device of claim 1 wherein configuring one or more of the display settings of the digital display device includes modifying at least one from the group consisting of a brightness level, a contrast level, a back light level, a saturation level, a sharpness level, a color temperature value, and a power consumption level.

6. The method for configuring a digital display device of claim 5 further comprising decreasing the power consumption level when the user is not viewing the digital display device or is not authorized to view the digital display device.

7. A machine comprising:
a processor;
a digital display device;
one or more sensors configured to determine whether a user is viewing the digital display device and to identify an amount of ambient light around the digital display device; and
a display application stored on computer readable memory and executed by the processor to configure one or more display settings on the digital display device in response to whether the user is viewing the digital display device and the amount of ambient light.

8. The machine of claim 7 wherein one or more sensors include a camera configured to determine whether the user is viewing the digital display device by identifying a head position of the user and a viewing location of the user.

9. The machine of claim 7 wherein one or more sensors include an infra red device configured to determine whether the user is viewing the digital display device by identifying a location of the user's eyes and a viewing location of the user.

10. The machine of claim 7 wherein one or more sensors are configured to detect and capture one or more hand movements and one or more finger movements from the user.

11. The machine of claim 10 wherein the display device is configured to display one or more interfaces for the user to interact with.

12. The machine of claim 10 wherein the display application is additionally configured to adjust one or more display settings on the digital display device in response to one or more of the captured hand movements and one or more of the captured finger movements.

13. A computer-readable program in a computer-readable medium comprising:
a display application configured to determine whether a user is viewing a digital display device and identify an amount of ambient light around the digital display device; and
wherein the display application is additionally configured to adjust one or more display settings on the digital display device in response to whether the user is viewing the digital display device and the amount of ambient light identified.

14. The computer-readable program in a computer-readable medium of claim 13 wherein the display application is further configured to adjust one or more display settings in response to one or more inputs entered by the user and captured by a sensor.

15. The computer-readable program in a computer-readable medium of claim 14 wherein the display application is additionally configured to instruct a display device to display a keyboard for the user to interact with when entering one or more of the inputs.
